(19) United States
(12) Patent Application Publication
(10) Pub. No.: US 2010/0313219 A1
(43) Pub. Date: Dec. 9, 2010

(54) METHOD AND APPARATUS FOR PREVIEWING BROADCAST CHANNEL IN PORTABLE TERMINAL

(75) Inventor: Bu-Seop JUNG, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/791,331

(22) Filed: Jun. 1, 2010

(30) Foreign Application Priority Data
Jun. 9, 2009 (KR) 10-2009-0050819

(51) Int. Cl. H04N 5/445; H04N 7/16

(52) U.S. Cl. 725/39; 725/62

(57) ABSTRACT

A method and apparatus for previewing a broadcast channel in a portable terminal are provided. The method of previewing the broadcast channel in the portable terminal includes detecting whether a channel preview event is generated in a state where a broadcast application is not accessed, if the preview event is generated, determining whether Packet IDentifier (PID) and Session Description Protocol (SDP) information for dynamic zapping data is pre-stored, if the PID and SDP information is pre-stored, performing frequency scanning and camping, and receiving and reproducing the dynamic zapping data on the basis of the stored PID and SDP information.

### PRIORITY

This application claims the benefit under 35 U.S.C. §119(a) of a Korean patent application filed in the Korean Intellectual Property Office on Jun. 9, 2010 and assigned Serial No. 10-2009-0050819, the entire disclosure of which is hereby incorporated by reference.

### BACKGROUND OF THE INVENTION

1. Field of the Invention

The present invention relates to a method and apparatus for previewing a broadcast channel in a portable terminal. More particularly, the present invention relates to a method and apparatus for providing a preview of a broadcast channel by using a dynamic zapping service.

2. Description of the Related Art

With the growing interest of users in digital multimedia broadcasting such as Digital Multimedia Broadcasting (DMB), Digital Video Broadcasting-Handheld (DVB-H), Media Forward Link Only (MediaFLO), etc., research is being performed to enable portable terminals to provide a digital multimedia broadcast service. In particular, a DVB-H system is a portable mobile broadcasting standard in which Digital Video Broadcasting-Terrestrial (DVB-T, i.e., a European terrestrial broadcasting standard) is modified according to the concept of a mobile broadcast service. The DVB-H system uses a time slicing scheme to decrease battery consumption of the portable terminals that receive the digital multimedia broadcast service.

FIG. 1 illustrates a time slicing scheme of a conventional Digital Video Broadcasting-Handheld (DVB-H) system.

As illustrated in FIG. 1, the time slicing scheme is a multiplexing scheme in which capacity of a transmission path is divided into constant time slots and then a packetized broadcast signal is carried and transmitted on each time slot. That is, when a broadcast server performs broadcasting using the time slicing scheme, a portable terminal receives a signal corresponding to a specific channel by turning on a receiver only during a specific time slot corresponding to the channel selected by a user. The receiver is turned off in the remaining time slots. As a result, the average power consumed by the receiver is reduced. In the example of FIG. 1, the user has selected to receive channel 2 so that the receiver is turned on during the time slot allocated to channel 2 and turned off during the time slots allocated to the remaining channels 1 and 3-6. Herein, when any bursts are continuously received, each burst reports a period (i.e., delta-T) indicating a next reception time so that a broadcast receiver of the portable terminal is turned on/off in synchronization with the period. Although the time slicing scheme can advantageously decrease power consumption, there is a problem in that it takes a long time to change from the channel in use to another channel.

To address this problem, a dynamic zapping service has conventionally been provided so as to broadcast data related to each channel independent from Audio/Video (A/V) channel data.

FIG. 2 and FIG. 3 illustrate conventional methods of transmitting dynamic zapping data in a DVB-H system.

In the dynamic zapping service, the data related to each channel, i.e., zapping data, may be transmitted with a shorter period than the A/V channel as illustrated in FIG. 2 (indicated by 201 and 203), or may be transmitted in parallel with a burst for transmitting the A/V channel as illustrated in FIG. 3 (indicated by 301 and 303). Therefore, a portable terminal that desires to change a channel receives the zapping data prior to the A/V data of the channel to be changed, and allows the zapping data to be reproducible until it is ready to reproduce the data by using the channel to be changed.

A typical terminal supporting DVB-H service requires a specific amount of time until a channel is selected for reproduction by accessing a DVB-H application. That is, when access to the DVB-H application is attempted by a user, the portable terminal attempts DVB-H frequency camping, and after the frequency camping is successfully achieved, receives and analyzes Program Specification Information/Service Information (PSI/SI). The PSI/SI includes overall program information such as DVB-H network information currently transmitted (e.g., a Single Frequency Network (SFN), a Multi Frequency Network (MFN), a frequency list, a cell IDentifier (ID) list, etc.), each channel's Packet ID (PID), and an Internet Protocol (IP) address. When the reception of the PSI/SI is complete, the portable terminal analyzes an Electronic Service Guide (ESG), i.e., a program list of broadcast services, and configures a channel list. As described above, since the conventional portable terminal receives and analyzes the PSI/SI and the ESG when accessing the DVB-H application, a significant amount of time is required until a broadcast channel is provided to the user, which may make the user feel bored or otherwise inconvenience the user. In addition, the conventional portable terminal has a problem in that, after accessing the application, the user does not know which broadcast is provided in each channel until the user reproduces data by directly selecting a channel. That is, there is a problem in that, when the user of the portable terminal desires to know which broadcast is provided in each channel, the user has to reproduce data by selecting respective channels one by one.

Accordingly, there is a need for an improved apparatus and method for previewing a broadcast channel in a portable terminal.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for previewing a broadcast channel in a portable terminal.

Another aspect of the present invention is to provide a method and apparatus for performing a channel preview before accessing a broadcast application using a dynamic zapping service in a portable terminal.

Another aspect of the present invention is to provide a method and apparatus for performing a channel preview before accessing a broadcast application by using a pre-obtained Packet IDentifier (PID) and Session Description Protocol (SDP) of a dynamic zapping service in a portable terminal.

Another aspect of the present invention is to provide a method and apparatus for performing a process of accessing a broadcast application while a channel preview is performed in a portable terminal.

In accordance with an aspect of the present invention, a method of previewing a broadcast channel in a portable terminal is provided. The method includes detecting whether a channel preview event is generated in a state where a broadcast application is not accessed, if the preview event is generated, determining whether PID and SDP information for dynamic zapping data is pre-stored, if the PID and SDP information is pre-stored, performing frequency scanning and camping, and receiving and reproducing the dynamic zapping data on the basis of the stored PID and SDP information.

In accordance with another aspect of the present invention, an apparatus for previewing a broadcast channel in a portable terminal is provided. The apparatus includes a broadcast reception module for receiving a broadcast signal from a broadcast server, and a controller for determining whether PID and SDP information for dynamic zapping data is pre-stored if a preview event is generated in a state where a broadcast application is not accessed, for performing frequency scanning and camping by controlling the broadcast reception module if the PID and SDP information is pre-stored, and for receiving and reproducing the dynamic zapping data on the basis of the stored PID and SDP information.

Other aspects, advantages, and salient features of the invention will become apparent to those skilled in the art from the following detailed description, which, taken in conjunction with the annexed drawings, discloses exemplary embodiments of the invention

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a conventional time slicing scheme of a Digital Video Broadcasting-Handheld (DVB-H) system;

FIG. 2 and FIG. 3 illustrate conventional methods of transmitting dynamic zapping data in a DVB-H system;

FIG. 4 is a block diagram of a portable terminal according to an exemplary embodiment of the present invention; and

FIG. 5 is a flowchart illustrating a process of providing a preview in a portable terminal according to an exemplary embodiment of the present invention.

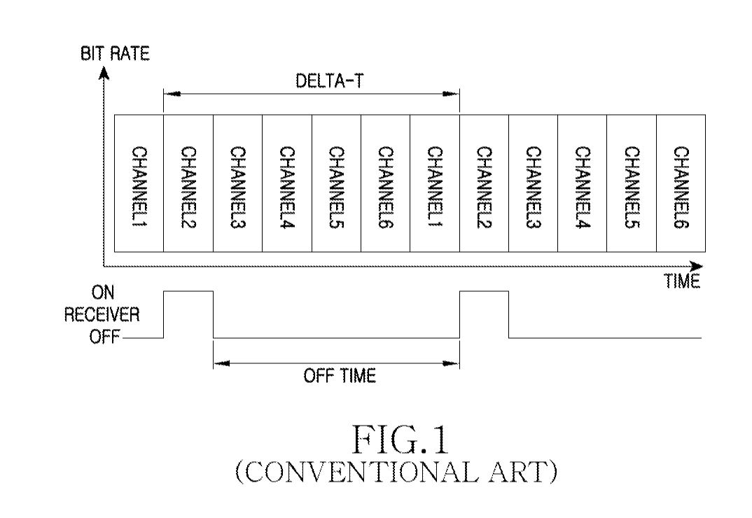

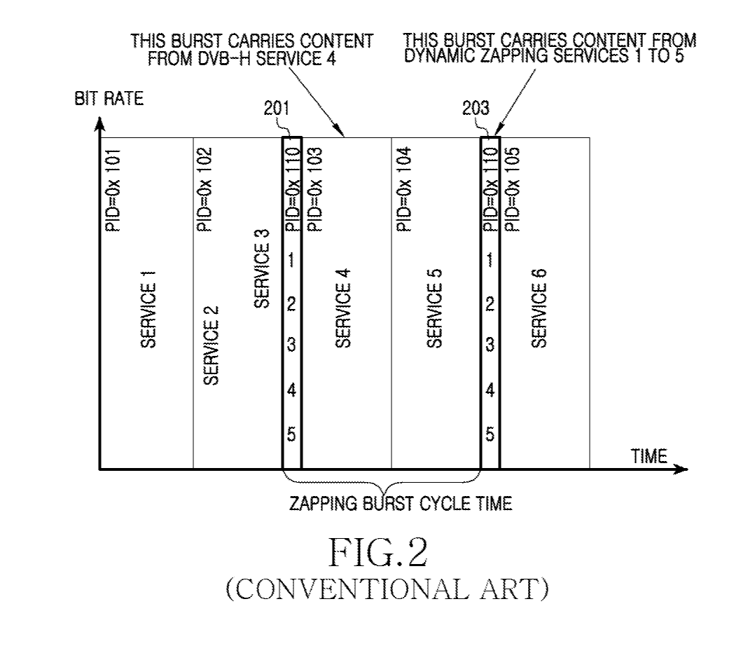

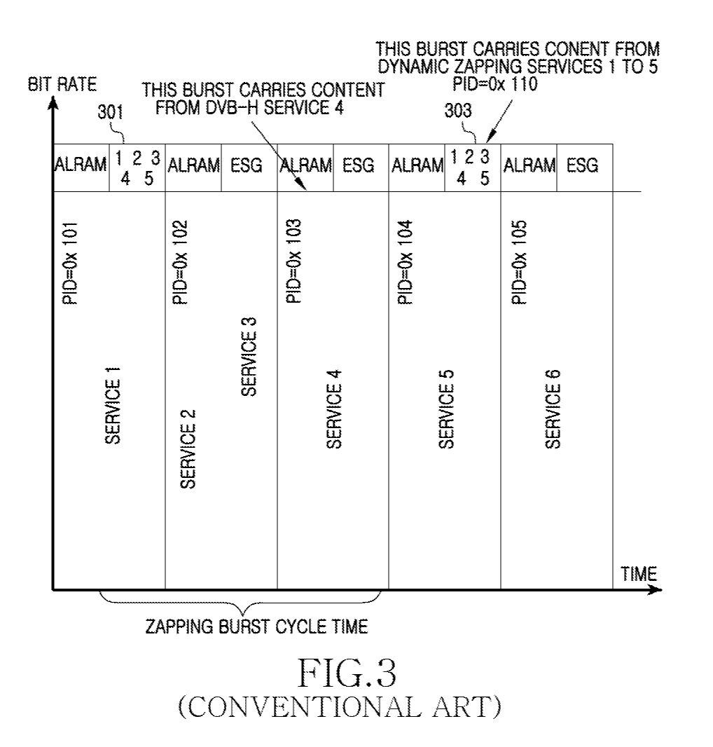

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention described hereinafter relate to a method and apparatus for previewing a channel before accessing a broadcast application by using a pre-obtained Packet IDentifier (PID) and Session Description Protocol (SDP) of a dynamic zapping service in a portable terminal Data of the dynamic zapping service (hereinafter, referred to as ‘dynamic zapping data’) is related to each broadcast channel. The dynamic zapping data is broadcast independently from Audio/Video (A/V) channel data, and is updated to data related to the A/V channel data in every burst. The dynamic zapping data may be configured with a combination of various types of data such as audio, video, still images, dynamic text, etc., or may be configured with only one type of data. The A/V channel data represents multimedia data consisting of audio and video signals for presenting broadcast contents. The dynamic zapping data is accessible in the same manner as typical A/V channel data. That is, the portable terminal detects the dynamic zapping data by using an Electronic Service Guide (ESG) received from a broadcast server, and obtains zapping data type and Internet Protocol (IP) address information from an SDP included in the ESG and thereafter obtains a PID value corresponding to the IP address using an Information Notification Table (INT) of Program Specific Information/Service Information (PSI/SI), and thus may receive the dynamic zapping data. The ESG denotes guide information for various broadcast contents provided from the broadcast server. The PSI/SI denotes system information such as channel information.

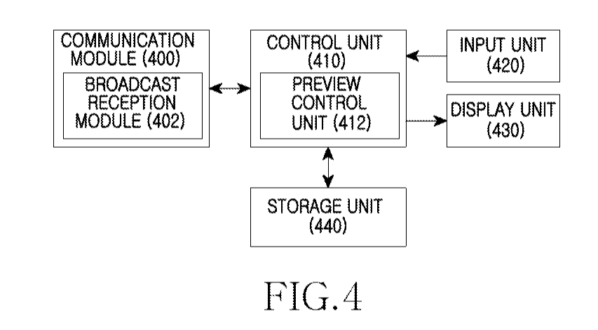

FIG. 4 is a block diagram of a portable terminal according to an exemplary embodiment of the present invention.

Referring to FIG. 4, the portable terminal includes a communication module 400, a control unit 410, an input unit 420, a display unit 430, and a storage unit 440. The communication module 400 includes a broadcast reception module 402 and the control unit 410 includes a preview control unit 412.

The communication module 400 performs a function of processing transmission and reception of a radio signal including data that is input and output through an antenna. According to exemplary embodiments of the present invention, the communication module 400 includes the broadcast reception module 402 to receive a digital multimedia broadcast signal. The broadcast reception module 402 operates under the control of the control unit 410. The broadcast reception module 402 analyzes a signal received under the control of the control unit 410, and provides the analysis result to the control unit 410.

The control unit 410 provides overall control of the portable terminal. For example, the control unit 410 performs processing and control of voice telephony and data communication. More particularly, according to an exemplary embodiment of the present invention, the control unit 410 includes the preview control unit 412, and thus performs processing and control for providing a channel preview function before accessing a broadcast application by using a pre-obtained PID and SDP of a dynamic zapping service.

For example, when a user selects a preview menu for broadcasting, the control unit 410 determines whether a PID and SDP for dynamic zapping data are present in the storage unit 440 and determines whether the PID and SDP are valid. If the PID and SDP are present and valid, the control unit 410 controls the broadcast reception module 402 to receive the dynamic zapping data by using the PID and SDP, and provides control and processing to reproduce the received dynamic zapping data. In this case, the control unit 410 performs control and processing for receiving and analyzing PSI/SI and ESG for accessing the broadcast application while the received dynamic zapping data is reproduced, and configures a channel list by using the received PSI/SI and ESG.

Meanwhile, if the preview control unit 412 determines that the PID and SDP are not present in the storage unit 440 or the PID and SDP stored in the storage unit 440 are invalid, the control unit 410 indicates that the preview service is invalid. In an exemplary implementation, the control unit 410 indicates that the preview service is invalid by using the display unit 430. Also, the control unit 410 may display a message for inquiring whether the broadcast application will be accessed.

When the user decides to access the broadcast application, the control unit 410 performs a process of accessing the broadcast application in the same manner as the conventional method. That is, the control unit 410 controls the broadcast reception module 402 to scan full frequency bands so as to camp on a frequency at which a broadcast signal is received. The control unit 410 receives the PSI/SI and the ESG from the broadcast reception module 402, configures the channel list by analyzing the received information, and controls the display unit 430 to display the channel list. According to exemplary embodiments of the present invention, the control unit 410 extracts the PID and SDP of the dynamic zapping data from the PSI/SI and the ESG, and stores the extracted PID and SDP in the storage unit 440.

The input unit 420 includes a plurality of alphanumeric keys to provide the control unit 410 with functions mapped to the keys to be selected by the user. In an exemplary implementation, the input unit 420 may provide the control unit 410 with a preview menu or a broadcast application access menu selected by the user.

The display unit 430 displays status information, alphanumeric characters, and images generated during the operation of the portable terminal. In an exemplary implementation, the display unit 430 may display a message for notifying that the preview service is invalid, preview data, and the channel list under the control of the control unit 410.

The storage unit 440 stores a variety of data and a program for processing and controlling an overall operation of the portable terminal. Further, the storage unit 440 may store the PID and SDP of the dynamic zapping service after receiving them from the control unit 410.

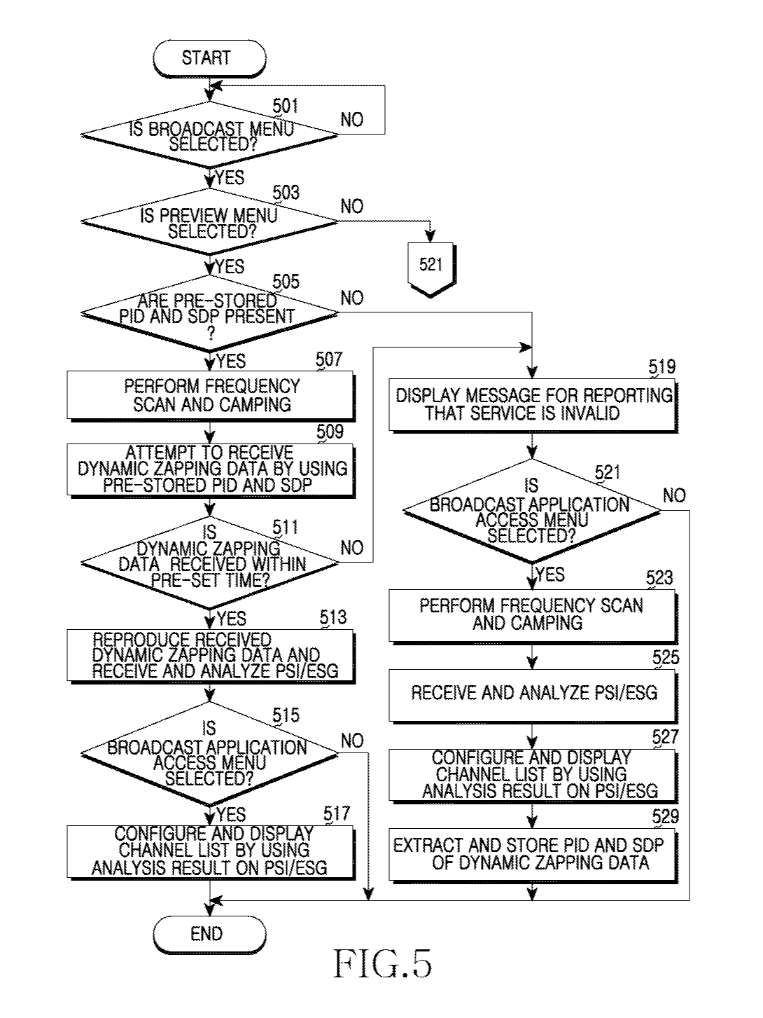

FIG. 5 is a flowchart illustrating a process of providing a preview in a portable terminal according to an exemplary embodiment of the present invention.

Referring to FIG. 5, when a broadcast menu is selected in step 501, the portable terminal determines whether a preview menu is selected in step 503. If the preview menu is not selected, the procedure proceeds to step 521. Otherwise, if the preview menu is selected, proceeding to step 505, the portable terminal determines whether a pre-stored PID and SDP are present.

If the pre-stored PID and SDP are present, proceeding to step 507, the portable terminal performs frequency scan and camping. In an exemplary implementation, the portable terminal performs scanning and camping on a previously accessed frequency. In step 509, the portable terminal attempts to receive dynamic zapping data using the pre-stored PID and SDP. In step 511, the portable terminal determines whether the dynamic zapping data is received within a pre-set time. That is, the portable terminal determines whether burst data having the PID is received.

If it is determined in step 511 that the dynamic zapping data is received within the pre-set time, in step 513, the portable terminal provides a user with information on each channel by reproducing the received dynamic zapping data, and receives and analyzes PSI/SI and ESG while the dynamic zapping data is reproduced. In step 515, the portable terminal determines whether a broadcast application access menu is selected. If the broadcast application access menu is selected, in step 517, the portable terminal configures and displays a channel list by using the analysis result on the PSI/SI and ESG, and then the procedure of FIG. 5 ends. Otherwise, if the broadcast application access menu is not selected, the procedure of FIG. 5 ends.

On the other hand, if it is determined in step 505 that the pre-stored PID and SDP are not present, proceeding to step 519, the portable terminal displays a message for notifying that a preview service is invalid. That is, the portable terminal notifies the user that the portable terminal does not have the PID and the SDP since it has never accessed the broadcast application previously and thus cannot provide the preview service.

Similarly, if it is determined in step 511 that the dynamic zapping data is not received within the pre-set time, proceeding to step 519, the portable terminal displays the message for notifying that the preview service is invalid. That is, when the portable terminal has previously attempted to receive the dynamic zapping data by using the PID and SDP obtained when accessing the broadcast application but the PID of the dynamic zapping data changes or disappears or when the content of the SDP changes and thus dynamic zapping data cannot be received by using the pre-stored PID and SDP, the portable terminal notifies the user that the preview service cannot be provided.

After notifying that the preview service is invalid, proceeding to step 521, the portable terminal determines whether the user selects the broadcast application access menu. If the broadcast application access menu is not selected, the procedure of FIG. 5 ends.

Otherwise, if the broadcast application access menu is selected, proceeding to step 523, the portable terminal camps on a frequency at which a broadcast signal is received by performing frequency scanning on all frequency bands. In step 525, the portable terminal receives and analyzes the PSI/SI and the ESG. In step 527, the portable terminal configures and displays the channel list by using the analysis result on the PSI/SI and the ESG. In step 529, the portable terminal extracts the PID and SDP of the dynamic zapping data from the analysis result on the PSI/SI and ESG and then stores the extracted PID and SDP. Thereafter, the procedure of FIG. 5 ends.

According to an exemplary embodiment of the present invention, a portable terminal performs a channel preview before accessing a broadcast application using a pre-obtained PID and SDP of a dynamic zapping service. Therefore, information on each channel may be provided to a user without having to directly receive each channel data. Further, by performing a process of accessing the broadcast application while the preview is performed, the present invention may advantageously decrease a time delay until the application is accessed after the application access is selected by the user in practice.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of previewing a broadcast channel in a portable terminal, the method comprising:
detecting whether a channel preview event is generated in a state where a broadcast application is not accessed;
if the preview event is generated, determining whether Packet IDentifier (PID) and Session Description Protocol (SDP) information for dynamic zapping data is pre-stored;
if the PID and SDP information is pre-stored, performing frequency scanning and camping; and
receiving and reproducing the dynamic zapping data on the basis of the stored PID and SDP information.

2. The method of claim 1, wherein the performing of the frequency scanning and camping comprises scanning and camping on a previously accessed frequency.

3. The method of claim 1, further comprising, if the PID and SDP information is not pre-stored, notifying that a preview service is invalid.

4. The method of claim 3, wherein the notifying that the preview service is invalid comprises displaying a message that the preview service is invalid.

5. The method of claim 1, further comprising:
determining whether the dynamic zapping data is received within a pre-set time; and
if the dynamic zapping data is not received within the pre-set time, notifying that a preview service is invalid.

6. The method of claim 5, wherein the notifying that the preview service is invalid comprises displaying a message that the preview service is invalid.

7. The method of claim 1, further comprising:
extracting a PID and SDP for the dynamic zapping data from a signal received from a broadcast server when accessing the broadcast application; and
if the PID and the SDP are not pre-stored in the portable terminal, storing the extracted PID and SDP.

8. The method of claim 1, further comprising:
during the receiving and reproducing of the dynamic zapping data, receiving Program Specific Information/Service Information (PSI/SI) and Electronic Service Guide (ESG) from a broadcast server and analyzing the PSI/SI and the ESG; and
configuring a channel list on the basis of an analysis result.

9. An apparatus for previewing a broadcast channel in a portable terminal, the apparatus comprising:
a broadcast reception module for receiving a broadcast signal from a broadcast server; and
a controller for determining whether Packet IDentifier (PID) and Session Description Protocol (SDP) information for dynamic zapping data is pre-stored if a preview event is generated in a state where a broadcast application is not accessed, for performing frequency scanning and camping by controlling the broadcast reception module if the PID and SDP information is pre-stored, and for receiving and reproducing the dynamic zapping data on the basis of the stored PID and SDP information.

10. The apparatus of claim 9, wherein the performing of the frequency scanning and camping comprises scanning and camping on a previously accessed frequency.

11. The apparatus of claim 9, wherein, if the PID and SDP information is not pre-stored, the controller controls a function of notifying that a preview service is invalid.

12. The apparatus of claim 11, wherein the notifying that the preview service is invalid comprises displaying a message that the preview service is invalid.

13. The apparatus of claim 9, wherein, if the dynamic zapping data is not received within a pre-set time, the controller controls a function of notifying that a preview service is invalid.

14. The apparatus of claim 13, wherein the notifying that the preview service is invalid comprises displaying a message that the preview service is invalid.

15. The apparatus of claim 9, wherein the controller controls a function of storing a PID and SDP for the dynamic zapping data by extracting the PID and SDP from a signal received from the broadcast server when accessing to the broadcast application.

16. The apparatus of claim 9, wherein, during the receiving and reproducing of the dynamic zapping data, the controller receives Program Specific Information/Service Information (PSI/SI) and Electronic Service Guide (ESG) from the broadcast server and analyzes the PSI/SI and the ESG, and configures a channel list on the basis of an analysis result.
